(19) United States
(12) Patent Application Publication
(10) Pub. No.: US 2021/0261802 A1
(43) Pub. Date: Aug. 26, 2021

(54) INKJET FLUID COMPOSITION

(71) Applicant: Hewlett-Packard Development Company, L.P., Spring, TX (US)

(72) Inventors: Kai-Kong Iu, San Diego, CA (US); Junji Yamamoto, San Diego, CA (US); Zhang-Lin Zhou, San Diego, CA (US); Qianhan Yang, San Diego, CA (US)

(21) Appl. No.: 17/059,642

(22) PCT Filed: Nov. 14, 2018
(86) PCT No.: PCT/US2018/061072

§ 371 Date: Nov. 30, 2020

(51) Int. Cl. C09D 11/101; C09D 11/033; C09D 11/037; C09D 11/107; C09D 11/38; B41J 2/21

(52) U.S. Cl. CPC C09D 11/101; C09D 11/033; B41J 2/2107; C09D 11/107; C09D 11/38; C09D 11/037

(57) ABSTRACT

An example of a thermal inkjet fluid composition includes a water soluble photoacid generator having substantially no absorbance at a radiation wavelength ranging from about 360 nm to about 410 nm, a water soluble polymeric sensitizer having absorption at the radiation wavelength ranging from about 360 nm to about 410 nm, a polymeric binder, and a balance of water. The water soluble polymeric sensitizer includes a functionalized aromatic chromophore moiety, a polyether chain, and an amide linkage or an ether linkage attaching one end of the polyether chain to the functionalized aromatic chromophore moiety.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. The technology has become a popular way of recording images on various media surfaces (e.g., paper), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a graph showing absorbance as a function of wavelength of an example photoacid generator (labeled “PAG Aqueous Solution”) and an example polymeric sensitizer (labeled “Photosensitizer in Ink Vehicle”), where absorbance is shown on the y-axis and wavelength (in nm) is shown on the x-axis;

FIG. 2 is a flow diagram illustrating an example of a printing method disclosed herein;

FIG. 3 is a flow diagram illustrating another example of a printing method disclosed herein; and

FIG. 4 is a graph showing the count per mL of the pigment and binder solids with a particle size greater than 2 μm in example ink compositions (labeled “Black,” “Cyan,” “Yellow,” and “Magenta”) and an example overcoat composition (labeled “Latex OC”) before and after UV exposure, where the count (in log 10 scale) is shown on the y-axis and the composition is identified on the x-axis.

### DETAILED DESCRIPTION

Disclosed herein is a thermal inkjet fluid composition including a water soluble photoacid generator having substantially no absorbance at a radiation wavelength ranging from about 360 nm to about 410 nm and a water soluble polymeric sensitizer having absorption at the radiation wavelength ranging from about 360 nm to about 410 nm. When the thermal inkjet fluid composition is exposed to a wavelength within this range, the polymeric sensitizer absorbs the energy and transfers it to the photoacid generator. In response, the photoacid generator breaks down and generates H⁺, which decreases the fluid's pH.

In some examples, the thermal inkjet fluid composition is an ink. In these examples, the thermal inkjet fluid composition also includes an anionic pigment. When the thermal inkjet fluid composition is applied on a substrate and exposed to a wavelength ranging from about 360 nm to about 410 nm, the generation of H⁺ and decrease in pH destabilizes the anionic pigment. The generation of H⁺ and decrease in pH may also destabilize a polymeric binder of the thermal inkjet fluid composition. This destabilization (of the anionic pigment and/or the polymeric binder) fixes the anionic pigment to the substrate.

In some other examples, the thermal inkjet fluid composition is an overcoat composition. In these examples, the thermal inkjet fluid composition may be applied over a thermal inkjet ink composition that includes an anionic pigment. When the thermal inkjet fluid composition and the thermal inkjet ink composition are applied on a substrate and exposed to a wavelength ranging from about 360 nm to about 410 nm, the generation of H⁺ and decrease in pH destabilizes the anionic pigment in the thermal inkjet ink composition. The generation of H⁺ and decrease in pH may also destabilize a polymeric binder of the thermal inkjet fluid composition or the thermal inkjet ink composition. This destabilization (of the anionic pigment and/or the polymeric binder) fixes the anionic pigment to the substrate.

Examples of the present disclosure may improve “ink efficiency”, e.g., by conserving resources, in that there is no need for separate printing head(s) containing a separate fixing fluid and/or a separate pretreatment fluid. A fixing fluid and/or a pretreatment fluid is/are not needed since the described destabilization of examples of the thermal inkjet fluid composition disclosed herein fixes the anionic pigment to the substrate.

Throughout this disclosure, a weight percentage that is referred to as “wt % active” refers to the loading of an active component of a dispersion or other formulation that is present in the thermal inkjet fluid composition (or another composition, e.g., a thermal inkjet ink composition). For example, the anionic pigment may be present in a water-based formulation (e.g., a stock solution or dispersion) before being incorporated into the ink composition. In this example, the wt % actives of the pigment accounts for the loading (as a weight percent) of the pigment that is present in the ink composition, and does not account for the weight of the other components (e.g., water, etc.) that are present in the formulation with the pigment. The term “wt %,” without the term actives, refers to either i) the loading (in the thermal inkjet fluid composition or another composition) of a 100% active component that does not include other non-active components therein, or ii) the loading (in the thermal inkjet fluid composition or another composition) of a material or component that is used “as is” and thus the wt % accounts for both active and non-active components.

Thermal Inkjet Fluid Compositions

Disclosed herein is a thermal inkjet fluid composition that includes a water soluble photoacid generator and a water soluble polymeric sensitizer. As mentioned above, the combination of the photoacid generator and the polymeric sensitizer may fix an anionic pigment to a substrate upon exposure to a wavelength ranging from about 360 nm to about 410 nm.

In an example, the thermal inkjet fluid composition, comprises: a water soluble photoacid generator having substantially no absorbance at a radiation wavelength ranging from about 360 nm to about 410 nm; a water soluble polymeric sensitizer having absorption at the radiation wavelength ranging from about 360 nm to about 410 nm, the water soluble polymeric sensitizer including: a functionalized aromatic chromophore moiety; a polyether chain; and an amide linkage or an ether linkage attaching one end of the polyether chain to the functionalized aromatic chromophore moiety; a polymeric binder; and a balance of water.

In an example, an initial pH of the thermal inkjet fluid composition decreases when the thermal inkjet fluid composition is exposed to the radiation wavelength ranging from about 360 nm to about 410 nm.

Photoacid Generators

The photoacid generator may be any photoacid generator that is: (i) water soluble, and (ii) has substantially no absorbance at a radiation wavelength ranging from about 360 nm to about 410 nm.

In one example, the water soluble photoacid generator may have a water solubility of at least 0.1 wt %. When the water solubility is at least 0.1 wt %, it means that of the total wt % of the water soluble photoacid generator added to water, at least 0.1 wt % of the total is water soluble. In some instances, the water soluble photoacid generator may have a water solubility of at least 0.5 wt %. In some instances, the water soluble photoacid generator may have a water solubility up to about 20 wt %. It is believed that higher water solubility, potentially up to 100 wt %, may also be achieved.

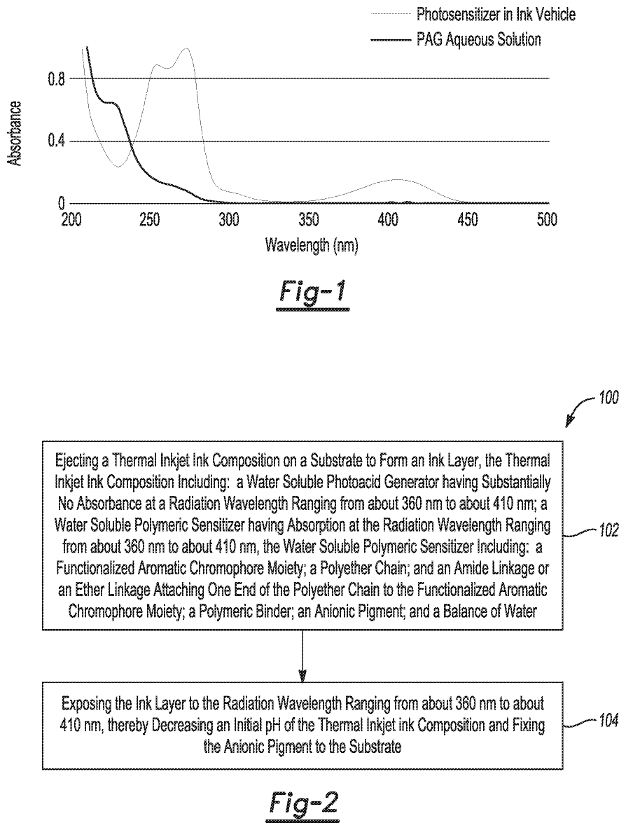

The photoacid generator used in examples of the present disclosure has substantially no absorbance at a radiation wavelength ranging from about 360 nm to about 410 nm. The photoacid generator may be considered to reflect the wavelengths at which the photoacid generator does not substantially absorb radiation. The phrase “having substantially no absorbance” or “does not substantially absorb” means that the absorptivity of the photoacid generator at a particular wavelength is less than 5% (e.g., 4%, 3%, 2%, 1%, 0%, etc.). The absorbance of an example photoacid generator (i.e., diphenyl iodonium nitrate) in an aqueous solution (labeled “PAG Aqueous Solution”) across a range of wavelengths is shown in FIG. 1. As shown in FIG. 1, the photoacid generator has substantially no absorbance at a radiation wavelength ranging from about 360 nm to about 410 nm.

In some examples, the photoacid generator is an aromatic onium salt selected from the group consisting of a diazonium salt, a phosphonium salt, a sulfonium salt, an iodonium salt, an imidosulfonate salt, an oxime sulfonate salt, a diazodisulfone salt, a disulfonate salt, an o-nitrobenzyl sulfonate salt, and combinations thereof; and an anion of the aromatic onium salt is selected from the group consisting of nitrate, chlorate, perchlorate, chloride, sulfate, and combinations thereof. One specific example of the photoacid generator is diphenyl iodonium nitrate.

In some examples, the water soluble photoacid generator is present in an amount ranging from about 0.1 wt % to about 10 wt % based on a total weight of the thermal inkjet fluid composition. In an example, the water soluble photoacid generator may be present in an amount of about 2 wt % based on a total weight of the thermal inkjet fluid composition. In another example, the water soluble photoacid generator may be present in an amount of about 1.2 wt % based on a total weight of the thermal inkjet fluid composition.

Polymeric Sensitizers

The polymeric sensitizer may be any polymeric sensitizer that is (i) water soluble, (ii) has absorbance at the radiation wavelength ranging from about 360 nm to about 410 nm, and (iii) includes a functionalized aromatic chromophore moiety, a polyether chain, and an amide linkage or an ether linkage attaching one end of the polyether chain to the functionalized aromatic chromophore moiety.

In one example, the polymeric sensitizer can have a water solubility of at least 0.1 wt %. When the water solubility is at least 0.1 wt %, it means that of the total wt % of the polymeric sensitizer added to water, at least 0.1 wt % of the total is water soluble. In some instances, the polymeric sensitizer may have a water solubility ranging from 0.1 wt % to 20 wt %. It is believed that higher water solubility, potentially up to 100 wt %, may also be achieved.

The polymeric sensitizer has absorbance at the radiation wavelength ranging from about 360 nm to about 410 nm. The phrase “having absorption” means that at least 5% of radiation having wavelengths within the specified range is absorbed. The absorbance of an example polymeric sensitizer (i.e., having the formula (I),

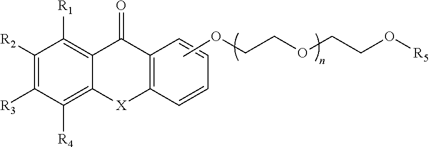

wherein R₁-R₄=H; R₅=Me (a methyl group), X=S; and n=11) in an aqueous vehicle (labeled “Photosensitizer in Ink Vehicle”) across a range of wavelengths is shown in FIG. 1. As shown in FIG. 1, the polymeric sensitizer has absorbance at a radiation wavelength ranging from about 360 nm to about 410 nm.

The water soluble polymeric sensitizer includes a functionalized aromatic chromophore moiety, a polyether chain, and an amide linkage or an ether linkage attaching one end of the polyether chain to the functionalized aromatic chromophore moiety. Each component of the polymeric sensitizer is discussed in greater detail below.

One portion of the polymeric sensitizer is the functionalized aromatic chromophore moiety. In some examples, the functionalized aromatic chromophore moiety of the water soluble polymeric sensitizer includes 3 to 4 conjugate rings and is selected from the group consisting of an anthrone moiety, an anthracene moiety, a phenanthrene moiety, a chrysene moiety, a pyrene moiety, a perylene moiety, a triphenylene moiety, a xanthene moiety, a cyanine moiety, a merocyanine moiety, an acridone moiety, an acridine moiety, an anthraquinone moiety, and a coumarin moiety.

In some examples, the functionalized aromatic chromophore moiety is an anthrone moiety. As used herein, the “anthrone moiety” has the formula:

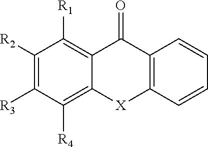

where X can be S, O, or NH. When X=S, the anthrone moiety is thioxanthrenone, and when X=O, the anthrone moiety is xanthenone. When X=NH, the anthrone moiety is acridinone. In this example, the functionalized aromatic chromophore moiety is the acridone moiety. When X=CO, the anthrone moiety is anthraquinone. In this example, the functionalized aromatic chromophore moiety is the anthraquinone moiety. R₁, R₂, R₃, and R₄ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group; and R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group.

In other examples, the functionalized aromatic chromophore moiety is an anthracene moiety. As used therein, the “anthracene moiety” has the formula:

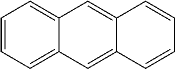 [SMILES: c1ccc2cc3ccccc3cc2c1]

where at least one hydroxyl functional group (—OH) is attached to at least one of the carbons in at least one of the benzene rings.

In still other examples, the functionalized aromatic chromophore moiety is a phenanthrene moiety. As used therein, the “phenanthrene moiety” has the formula:

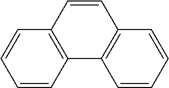 [SMILES: c1ccc2c(c1)ccc1ccccc12]

where at least one hydroxyl functional group (—OH) is attached to at least one of the carbons in at least one of the benzene rings.

In yet other examples, the functionalized aromatic chromophore moiety is a chrysene moiety. As used therein, the “chrysene moiety” has the formula:

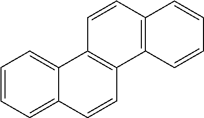 [SMILES: c1ccc2c(c1)ccc1c3ccccc3ccc21]

where at least one hydroxyl functional group (—OH) is attached to at least one of the carbons in at least one of the benzene rings.

In some other examples, the functionalized aromatic chromophore moiety is a pyrene moiety. As used therein, the “pyrene moiety” has the formula:

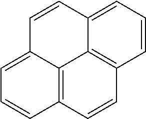 [SMILES: c1cc2ccc3cccc4ccc(c1)c2c34]

where at least one hydroxyl functional group (—OH) is attached to at least one of the carbons in at least one of the benzene rings.

In still some other examples, the functionalized aromatic chromophore moiety is a perylene moiety. As used therein, the “perylene moiety” has the formula:

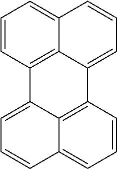 [SMILES: c1cc2cccc3c4cccc5cccc(c(c1)c23)c54]

where at least one hydroxyl functional group (—OH) is attached to at least one of the carbons in at least one of the benzene rings.

In yet some other examples, the functionalized aromatic chromophore moiety is a triphenylene moiety. As used therein, the “triphenylene moiety” has the formula:

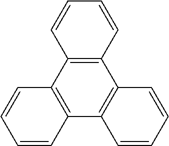 [SMILES: c1ccc2c(c1)c1ccccc1c1ccccc21]

where at least one hydroxyl functional group (—OH) is attached to at least one of the carbons in at least one of the benzene rings.

In other examples, the functionalized aromatic chromophore moiety is an xanthene moiety. As used therein, the “xanthene moiety” has the formula:

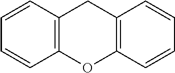 [SMILES: c1ccc2c(c1)Cc1ccccc1O2]

where at least one hydroxyl functional group (—OH) is attached to at least one of the carbons in at least one of the benzene rings.

In still other examples, the functionalized aromatic chromophore moiety is a cyanine moiety. As used therein, the “cyanine moiety” has the formula:

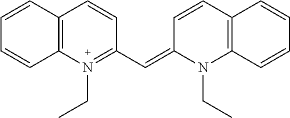

where at least one hydroxyl functional group (—OH) is attached to at least one of the carbons in at least one of the benzene rings.

In yet other examples, the functionalized aromatic chromophore moiety is a merocyanine moiety. As used therein, the “merocyanine moiety” has the formula:

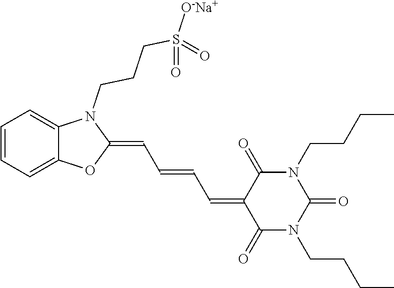

where at least one hydroxyl functional group (—OH) is attached to at least one of the carbons in the benzene ring.

In some other examples, the functionalized aromatic chromophore moiety is an acridine moiety. As used therein, the “acridine moiety” has the formula:

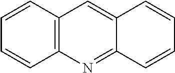 [SMILES: c1ccc2nc3ccccc3cc2c1]

where at least one hydroxyl functional group (—OH) is attached to at least one of the carbons in at least one of the benzene rings.

In still some other examples, the functionalized aromatic chromophore moiety is a coumarin moiety. As used therein, the “coumarin moiety” has the formula:

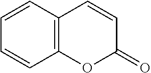 [SMILES: O=c1ccc2ccccc2o1]

where at least one hydroxyl functional group (—OH) is attached to at least one of the carbons in the benzene ring.

The other portion of the polymeric sensitizer disclosed herein includes polyether chain(s). Suitable examples of the polyether chains include polyethylene glycol or methyl substituted polyethylene glycol. In an example, one end of the polyether chain is attached to the functionalized aromatic chromophore moiety through an amide linkage or an ether linkage. The molecular weight of the polyether chain can, in some cases, affect the solubility of the final polymeric sensitizer. For example, a higher ratio of oxygen atoms to carbon atoms in the polyether chain tends to render the polymeric sensitizer more water soluble. The molecular weight of the polyether chain can also affect the degree to which the polymeric sensitizer can migrate in the thermal inkjet fluid composition. Longer polyether chains can make it more difficult for the polymeric sensitizer to move within the thermal inkjet fluid composition, thus decreasing migration. For example, the aromatic chromophore moiety (in the polymeric sensitizer), if it were unbound to the polyether side chain, may generally easily diffuse/migrate into or be adsorbed by the polymeric binder and/or anionic pigment (when present). It is believed that the polyether side chain in examples of the polymeric sensitizer of the present disclosure may help to prevent or substantially prevent such diffusion/migration or adsorption. As such, the molecular weight and length of the polyether chain can be selected to provide good water solubility and low or no migration of the polymeric sensitizer in the thermal inkjet fluid composition.

As noted above, the amide linkage or the ether linkage connects the polyether chain to the functionalized aromatic chromophore moiety. It has been found that the polymeric sensitizer disclosed herein is hydrolytically stable due to the amide or ether linkage, especially when compared to sensitizers including an ester linkage. As such, the amide or ether linkage improves the stability of the polymeric sensitizer in the thermal inkjet fluid composition.

As used herein, “amide linkage” refers to either an amide group or an amide group with a bridging group (shown in some formulas as “Y”) attached to the carbon atom of the amide group. The amide linkage connects one of the benzene rings of the functionalized aromatic chromophore moiety with the polyether chain. The polyether chain may be directly bonded to the nitrogen atom of the amide group, and the carbon atom of the amide group may either be directly bonded, or linked through the bridging group to a carbon atom in the one benzene ring of the functionalized aromatic chromophore moiety. It is to be understood that the amide linkage may be attached to the functionalized aromatic chromophore moiety at different positions on the one benzene ring. For example, the carbon atom of the amide group, or the carbon atom of the bridging group may be attached to the carbon atom at the ortho position, meta position, or the para position of the ring. The position at which the amide linkage is attached depends, in part, on the starting material used as the functionalized aromatic chromophore moiety when forming the polymeric sensitizer. The amide linkage can be formed by a suitable reaction, such as a substitution reaction or a condensation reaction.

As used herein, “ether linkage” refers to the ether group (i.e., R′—O—R″) that connects one of the benzene rings of the functionalized aromatic chromophore moiety with the polyether chain. R′ and R″ of the ether linkage may be part of the functionalized aromatic chromophore moiety and the polyether chain, respectively. For example, the R′ of the ether linkage may be one of the carbon atoms in the one benzene ring and the R″ of the ether linkage may be the carbon atom at one end of the polyether chain. It is to be understood that the ether linkage may be attached to the functionalized aromatic chromophore moiety at different positions on the one benzene ring. For example, the R′ carbon atom of the ether linkage may be the carbon atom at the ortho position, meta position, or the para position of the ring. The position at which the ether linkage is attached depends, in part, on the starting material used as the functionalized aromatic chromophore moiety when forming the polymeric sensitizer. The ether linkage can be formed by a suitable reaction, such as a substitution reaction.

In some examples, the functionalized aromatic chromophore moiety, polyether chain, and amide or ether linkage do not form the entire polymeric sensitizer. In some examples, the polymeric sensitizer may include additional functionalized aromatic chromophore moieties and/or polyether chains. In some other examples, the polymeric sensitizer may have functional group(s) attached to an opposed end of the polyether chain.

In one example, the water soluble polymeric sensitizer has a formula (I) of:

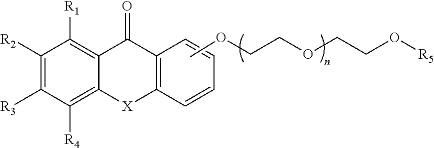

and wherein: R₁, R₂, R₃, R₄, and R₅ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group; R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group; X is O, S, or NH; and n ranges from 1 to 200. Some examples of suitable alkyl groups include methyl, ethyl, propyl, isopropyl, butyl, isobutyl, pentyl, hexyl, etc. One example of a suitable alkene group is an ethylene group. Some examples of suitable aryl groups include phenyl, phenylmethyl, etc. As depicted in formula (I), the linkage is an ether linkage. In one example, the water soluble polymeric sensitizer has the formula (I), wherein R₁-R₄=H; R₅=Me, X=S; and n=11.

In another example, the polymeric sensitizer has a formula (II) of:

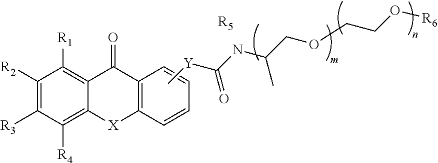

and wherein: R₁, R₂, R₃, R₄, R₅, and R₆ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group; R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group; Y is a bond, (CH₂)_{q}, or O(CH₂)_{q}, wherein q is any integer from 1 to 100; X is O, S, or NH; m ranges from 1 to 200; and n ranges from 1 to 200. Some examples of suitable alkyl groups include methyl, ethyl, propyl, isopropyl, butyl, isobutyl, pentyl, hexyl, etc. One example of a suitable alkene group is an ethylene group. Some examples of suitable aryl groups include phenyl, phenylmethyl, etc. As depicted in formula (II), the linkage is an amide linkage.

In other examples, the thermal inkjet fluid composition further comprises an additional functionalized aromatic chromophore moiety attached to the opposed end of the polyether chain through an additional ether linkage or an additional amide linkage.

In one example, the polymeric sensitizer has the formula (III) of:

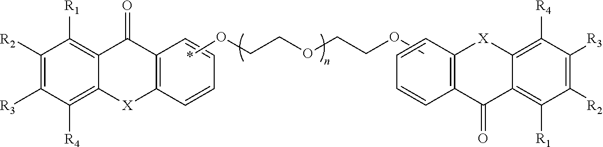

which includes an additional anthrone moiety attached to the opposed end of the polyether chain through the additional ether linkage.

In formula (III), R₁, R₂, R₃, and R₄ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group. R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group. As mentioned above, some examples of suitable alkyl groups include methyl, ethyl, propyl, isopropyl, butyl, isobutyl, pentyl, hexyl, etc.; an example of a suitable alkene group is an ethylene group; and some examples of suitable aryl groups include phenyl, phenylmethyl, etc. It is to be understood that these groups may be used in any of the formulas disclosed herein. In formula (III), X is O, S, or NH and the polyether chain has n number of repeating monomer units, where n ranges from 1 to 200.

In another example, the polymeric sensitizer has the formula (IV) of:

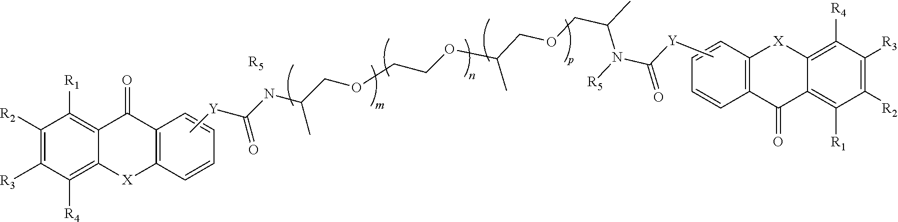

which includes an additional anthrone moiety attached to the opposed end of the polyether chain through the additional amide linkage.

In formula (IV), R₁, R₂, R₃, R₄, and R₅ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group. R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group. As mentioned above, some examples of suitable alkyl groups include methyl, ethyl, propyl, isopropyl, butyl, isobutyl, pentyl, hexyl, etc.; an example of a suitable alkene group is an ethylene group; and some examples of suitable aryl groups include phenyl, phenylmethyl, etc. In formula (IV), X is O, S, or NH, Y is a bond, (CH₂)_{q}, or O(CH₂)_{q}, where q is any integer from 1 to 100, the first polyether chain has m number of repeating monomer units, where m ranges from 1 to 200, the second polyether chain has n number of repeating monomer units, where n ranges from 1 to 200, and the third polyether chain has p number of repeating monomer units, where p ranges from 1 to 200.

In yet another example, the polymeric sensitizer includes first, second, and third functionalized aromatic chromophore moieties. Additionally, in this example, the first, second, and third functionalized aromatic chromophore moieties are each individually and respectively attached to first, second, and third amide or ether linkages. The first, second, and third amide or ether linkages are attached to first, second, and third polyether chains, respectively. In an example, the first amide or ether linkage attaches one end of the first polyether chain to the first functionalized aromatic chromophore moiety. The opposed end of the first polyether chain is attached to each of the second and third polyether chains through carbon atom(s).

Two examples of the polymeric sensitizer having three anthrone moieties respectively have the formulas (V, with three ether linkages) and (VI, with three amide linkages):

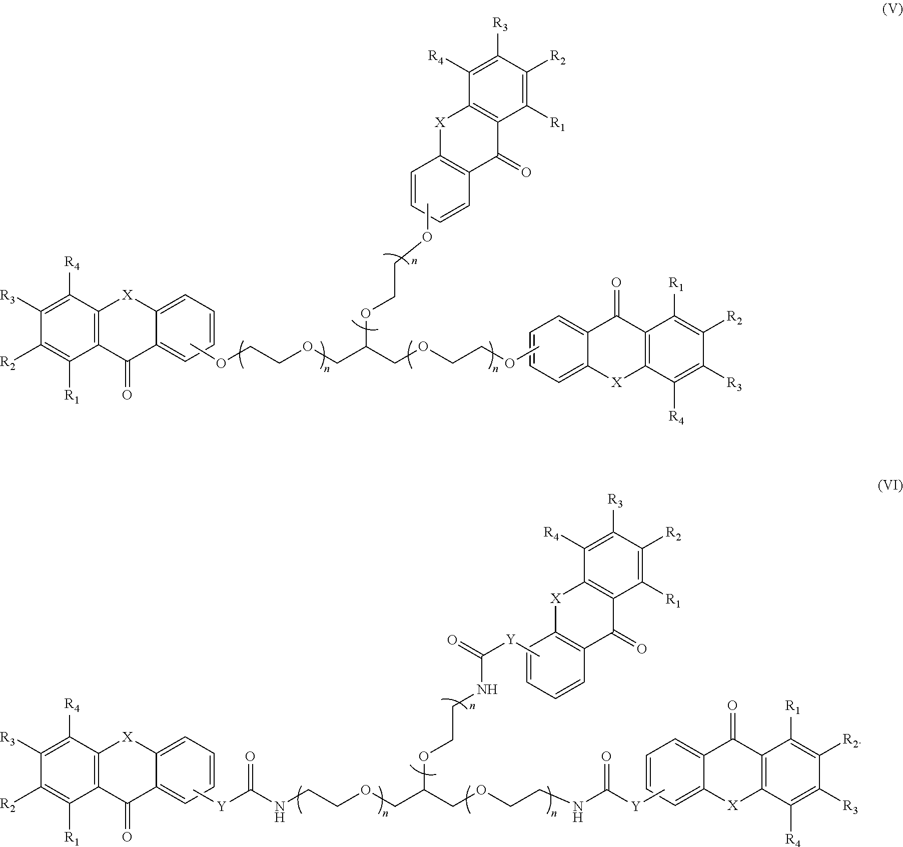

In formulas (V) and (VI), R₁, R₂, R₃ and R₄ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group. R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group. As mentioned above, some examples of suitable alkyl groups include methyl, ethyl, propyl, isopropyl, butyl, isobutyl, pentyl, hexyl, etc.; one example of a suitable alkene group is an ethylene group; and some examples of suitable aryl groups include phenyl, phenylmethyl, etc. In each of formulas (V) and (VI), each of the polyether chains has n number of repeating monomer units, where n ranges from 1 to 200, and X is O, S, or NH. In formula (VI), Y is a bond, (CH₂)_{q}, or O(CH₂)_{q}, where q is any integer from 1 to 100.

Still further, in another example, the polymeric sensitizer includes first, second, third, and fourth functionalized aromatic chromophore moieties. In this example, the first, second, third, and fourth functionalized aromatic chromophore moieties are each individually and respectively attached to first, second, third, and fourth amide or ether linkages. The first, second, third, and fourth amide or ether linkages are attached to first, second, third, and fourth polyether chains, respectively. In an example, the first amide or ether linkage attaches one end of the first polyether chain to the first functionalized aromatic chromophore moiety. The opposed end of the first polyether chain is attached to each of the second, third, and fourth polyether chains through carbon atom(s).

Two examples of the polymeric sensitizer having four anthrone moieties respectively have the formulas (VII, with four ether linkages) and (VIII, with four amide linkages):

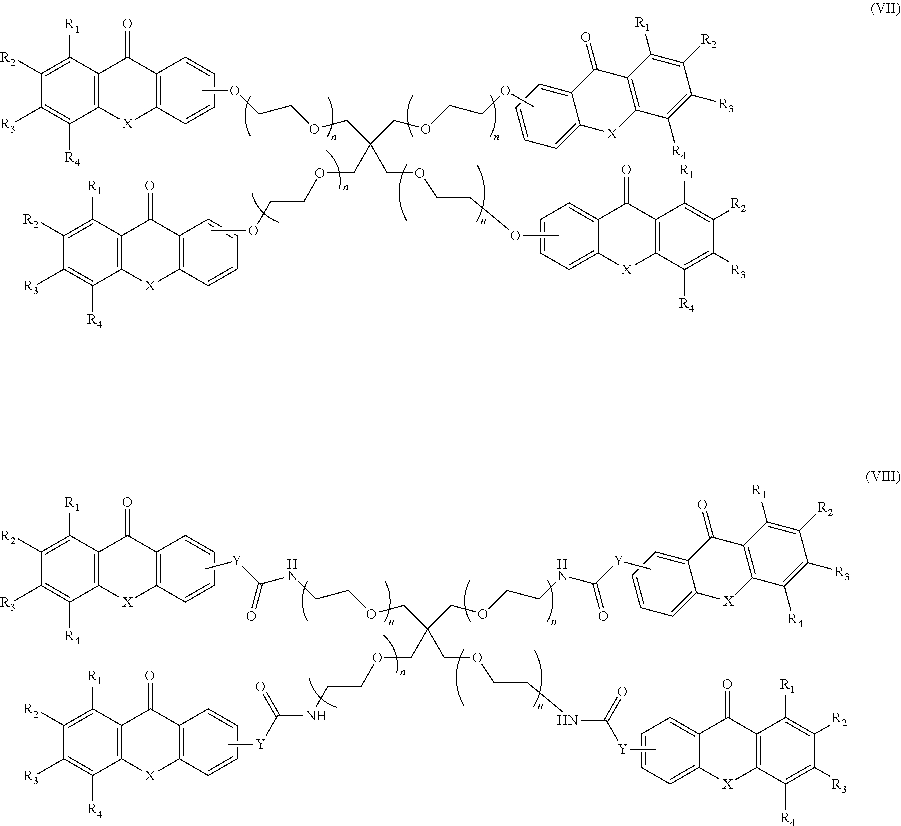

In formulas (VII) and (VIII), R₁, R₂, R₃ and R₄ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group. R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group. As mentioned above, some examples of suitable alkyl groups include methyl, ethyl, propyl, isopropyl, butyl, isobutyl, pentyl, hexyl, etc.; one example of a suitable alkene group is an ethylene group; and some examples of suitable aryl groups include phenyl, phenylmethyl, etc. In each of formulas (VII) and (VIII), each of the polyether chains has n number of repeating monomer units, where n ranges from 1 to 200, and X is O, S, or NH. In formula (VIII), Y is a bond, (CH₂)_{q}, or O(CH₂)_{q}, where q is any integer from 1 to 100.

In each of formulas I through VIII, it is noted that the polyether chain(s) may be connected to different positions of the one benzene ring of the anthrone moiety or moieties. In each of formulas I through VIII, it is also noted that different functionalized aromatic chromophore moieties may be used in place of the anthrone moiety or moieties.

In some examples, the water soluble polymeric sensitizer is present in an amount ranging from about 0.1 wt % to about 10 wt % based on a total weight of the thermal inkjet fluid composition. In an example, the water soluble polymeric sensitizer may be present in an amount of about 4 wt % based on a total weight of the thermal inkjet fluid composition. In another example, the water soluble polymeric sensitizer may be present in an amount of about 2.4 wt % based on a total weight of the thermal inkjet fluid composition.

In one example, the water soluble polymeric sensitizer is present in an amount ranging from about 0.1 wt % to about 10 wt % based on a total weight of the thermal inkjet fluid composition; and the water soluble photoacid generator is present in an amount ranging from about 0.1 wt % to about 10 wt % based on the total weight of the thermal inkjet fluid composition.

Polymeric Binders

The thermal inkjet fluid composition also includes a polymeric binder. Examples of the polymeric binder are selected from the group consisting of a polyester-polyurethane binder, a polyether-polyurethane binder, a polycarbonate-polyurethane binder, and a latex binder. In other examples, hybrids of any of these binders may be used.

In an example, the thermal inkjet fluid composition includes the polyester-polyurethane binder. In an example, the polyester-polyurethane binder is a sulfonated polyester-polyurethane binder. The sulfonated polyester-polyurethane binder can include diaminesulfonate groups. In an example, the polyester-polyurethane binder is a sulfonated polyester-polyurethane binder, and is one of: i) an aliphatic compound including multiple saturated carbon chain portions ranging from C₄ to C₁₀ in length, and that is devoid of an aromatic moiety, or ii) an aromatic compound including an aromatic moiety and multiple saturated carbon chain portions ranging from C₄ to C₁₀ in length.

In one example, the sulfonated polyester-polyurethane binder can be anionic. In further detail, the sulfonated polyester-polyurethane binder can also be aliphatic, including saturated carbon chains as part of the polymer backbone or as a side-chain thereof, e.g., C₂ to C₁₀, C₃ to C₈, or C₃ to C₆ alkyl. These polyester-polyurethane binders can be described as “alkyl” or “aliphatic” because these carbon chains are saturated and because they are devoid of aromatic moieties. An example of an anionic aliphatic polyester-polyurethane binder that can be used is IMPRANIL® DLN-SD (CAS #375390-41-3; Mw 45,000 Mw; Acid Number 5.2; Tg −47° C.; Melting Point 175-200° C.) from Covestro. Example components used to prepare the IMPRANIL® DLN-SD or other similar anionic aliphatic polyester-polyurethane binders can include pentyl glycols (e.g., neopentyl glycol); C₄ to C₁₀ alkyldiol (e.g., hexane-1,6-diol); C₄ to C₁₀ alkyl dicarboxylic acids (e.g., adipic acid); C₄ to C₁₀ alkyl diisocyanates (e.g., hexamethylene diisocyanate (HDI)); diamine sulfonic acids (e.g., 1-[(2-aminoethyl)amino]-ethanesulfonic acid); etc.

Alternatively, the sulfonated polyester-polyurethane binder can be aromatic (or include an aromatic moiety) and can include aliphatic chains. An example of an aromatic polyester-polyurethane binder that can be used is DISPERCOLL® U42 (CAS #157352-07-3). Example components used to prepare the DISPERCOLL® U42 or other similar aromatic polyester-polyurethane binders can include aromatic dicarboxylic acids, e.g., phthalic acid; C₄ to C₁₀ alkyl dialcohols (e.g., hexane-1,6-diol); C₄ to C₁₀ alkyl diisocyanates (e.g., hexamethylene diisocyanate (HDI)); diamine sulfonic acids (e.g., 1-[(2-aminoethyl)amino]-ethanesulfonic acid); etc.

Other types of polyester-polyurethanes can also be used, including IMPRANIL® DL 1380, which can be somewhat more difficult to jet from thermal inkjet printheads compared to IMPRANIL® DLN-SD and DISPERCOLL® U42, but still can be acceptably jetted in some examples.

The polyester-polyurethane binders disclosed herein may have a weight average molecular weight (Mw, g/mol) ranging from about 20,000 to about 300,000. As examples, the weight average molecular weight can range from about 50,000 to about 500,000, from about 100,000 to about 400,000, or from about 150,000 to about 300,000.

The polyester-polyurethane binders disclosed herein may have an acid number that ranges from about 1 mg/g KOH to about 50 mg/g KOH. For this binder, the term “acid number” refers to the mass of potassium hydroxide (KOH) in milligrams that is used to neutralize one gram of the sulfonated polyester-polyurethane binder. To determine this acid number, a known amount of a sample of the polyester-polyurethane binder may be dispersed in water and the aqueous dispersion may be titrated with a polyelectrolyte titrant of a known concentration. In this example, a current detector for colloidal charge measurement may be used. An example of a current detector is the Mütek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC).

As examples, the acid number of the sulfonated polyester-polyurethane binder can range from about 1 mg KOH/g to about 200 mg KOH/g, from about 2 mg KOH/g to about 100 mg KOH/g, or from about 3 mg KOH/g to about 50 mg KOH/g.

In an example of the thermal inkjet fluid composition, the polyester-polyurethane binder has a weight average molecular weight (g/mol) ranging from about 20,000 to about 300,000 and an acid number ranging from about 1 mg KOH/g to about 50 mg KOH/g.

The average particle size of the polyester-polyurethane binders disclosed herein may range from about 20 nm to about 500 nm. As examples, the sulfonated polyester-polyurethane binder can have an average particle size ranging from about 20 nm to about 500 nm, from about 50 nm to about 350 nm, or from about 100 nm to about 250 nm. The particle size of any solids herein, including the average particle size of the dispersed polymer binder, can be determined using a NANOTRAC® Wave device, from Microtrac, e.g., NANOTRAC® Wave II or NANOTRAC® 150, etc, which measures particles size using dynamic light scattering. Average particle size can be determined using particle size distribution data generated by the NANOTRAC® Wave device.

Other examples of the thermal inkjet fluid composition include a polyether-polyurethane binder. Examples of polyether-polyurethanes that may be used include IMPRANIL® LP DSB 1069, IMPRANIL® DLE, IMPRANIL® DAH, or IMPRANIL® DL 1116 (Covestro (Germany)); or HYDRAN® WLS-201 or HYDRAN® WLS-201K (DIC Corp. (Japan)); or TAKELAC® W-6061T or TAKELAC® WS-6021 (Mitsui (Japan)).

Still other examples of the thermal inkjet fluid composition include a polycarbonate-polyurethane binder. Examples of polycarbonate-polyurethanes that may be used as the polymeric binder include IMPRANIL® DLC-F or IMPRANIL® DL 2077 (Covestro (Germany)); or HYDRAN® WLS-213 (DIC Corp. (Japan)); or TAKELAC® W-6110 (Mitsui (Japan)).

In still other examples, the thermal inkjet fluid composition includes a latex polymer binder. The term “latex polymer” generally refers to any dispersed polymer prepared from acrylate and/or methacrylate monomers, including an aromatic (meth)acrylate monomer that results in aromatic (meth)acrylate moieties as part of the latex. In an example, the latex polymer may be devoid of styrene. In some examples, the latex particles can include a single heteropolymer that is homogenously copolymerized. In another example, a multi-phase latex polymer can be prepared that includes a first heteropolymer and a second heteropolymer. The two heteropolymers can be physically separated in the latex particles, such as in a core-shell configuration, a two-hemisphere configuration, smaller spheres of one phase distributed in a larger sphere of the other phase, interlocking strands of the two phases, and so on. If a two-phase polymer, the first heteropolymer phase can be polymerized from two or more aliphatic (meth)acrylate ester monomers or two or more aliphatic (meth)acrylamide monomers. The second heteropolymer phase can be polymerized from a cycloaliphatic monomer, such as a cycloaliphatic (meth)acrylate monomer or a cycloaliphatic (meth)acrylamide monomer. The first or second heteropolymer phase can include the aromatic (meth)acrylate monomer, e.g., phenyl, benzyl, naphthyl, etc. In one example, the aromatic (meth)acrylate monomer can be a phenoxylalkyl (meth)acrylate that forms a phenoxylalkyl (meth)acrylate moiety within the latex polymer, e.g. phenoxylether, phenoxylpropyl, etc. The second heteropolymer phase can have a higher T_{g} than the first heteropolymer phase in one example. The first heteropolymer composition may be considered a soft polymer composition and the second heteropolymers composition may be considered a hard polymer composition. If a two-phase heteropolymer, the first heteropolymer composition can be present in the latex polymer in an amount ranging from about 15 wt % to about 70 wt % of a total weight of the polymer particle, and the second heteropolymer composition can be present in an amount ranging from about 30 wt % to about 85 wt % of the total weight of the polymer particle. In other examples, the first heteropolymer composition can be present in an amount ranging from about 30 wt % to about 40 wt % of a total weight of the polymer particle, and the second heteropolymer composition can be present in an amount ranging from about 60 wt % to about 70 wt % of the total weight of the polymer particle.

In more general terms, whether there is a single heteropolymer phase, or there are multiple heteropolymer phases, heteropolymer(s) or copolymer(s) can include a number of various types of copolymerized monomers, including aliphatic(meth)acrylate ester monomers, such as linear or branched aliphatic (meth)acrylate monomers, cycloaliphatic (meth)acrylate ester monomers, or aromatic monomers. However, in accordance with the present disclosure, the aromatic monomer(s) selected for use can include an aromatic (meth)acrylate monomer. To be clear, reference to an “aromatic (meth)acrylate” does not include the copolymerization of two different monomers copolymerized together into a common polymer, e.g., styrene and methyl methacrylate. Rather, the term “aromatic (meth)acrylate” refers to a single aromatic monomer that is functionalized by an acrylate, methacrylate, acrylic acid, or methacrylic acid, etc.

In an example, the polymeric binder is an acrylic latex binder.

The weight average molecular weight (g/mol) of the latex polymer can be from 50,000 to 500,000, for example. The acid number of the latex polymer can be from 2 mg KOH/g to 40 mg KOH/g, from 2 mg KOH/g to 30 mg KOH/g, or 3 mg KOH/g to 26 mg KOH/g, or 4 mg KOH/g to 20 mg KOH/g, for example.

The latex polymer can be in acid form, such as in the form of a polymer with (meth)acrylic acid surface groups, or may be in its salt form, such as in the form of a polymer with poly(meth)acrylate groups.

In an example, any of the polyurethane-based polymeric binders may be present in the thermal inkjet fluid composition in a total amount ranging from about 2 wt % active to about 15 wt % active of the total weight of the thermal inkjet fluid composition. In another example, the latex polymer can be present in the thermal inkjet fluid composition ink at a relatively high concentration, e.g., from 5 wt % active to 30 wt % active, from 5 wt % active to 25 wt % active, from 5 wt % active to 20 wt % active, from 6 wt % active to 15 wt % active, or from 7 wt % active to 12 wt % active, for example.

The polymeric binder (prior to being incorporated into the thermal inkjet fluid composition) may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the binder dispersion become part of the aqueous liquid vehicle in the thermal inkjet fluid composition.

Aqueous Vehicles

In addition to the water soluble photoacid generator, the water soluble polymeric sensitizer, and the polymeric binder, the thermal inkjet fluid composition includes a balance of water. The water may be part of an aqueous vehicle.

As used herein, the term “aqueous vehicle” may refer to the liquid fluid with which the water soluble photoacid generator, the water soluble polymeric sensitizer, and the polymeric binder are mixed to form the thermal inkjet fluid composition. A wide variety of vehicles may be used with the thermal inkjet fluid composition of the present disclosure. The vehicle may include a co-solvent, an anti-kogation agent, an anti-decel agent, a surfactant, a biocide, a chelating agent, a pH adjuster, or combinations thereof. In an example, the vehicle consists of water and the co-solvent, the anti-kogation agent, the anti-decel agent, the surfactant, the biocide, the chelating agent, the pH adjuster, or a combination thereof. In another example, the vehicle consists of water and the co-solvent, the surfactant, the anti-kogation agent, the pH adjuster, or a combination thereof.

The vehicle may include co-solvent(s). The co-solvent(s) may be present in an amount ranging from about 4 wt % to about 30 wt % (based on the total weight of the thermal inkjet fluid composition). Examples of co-solvents include alcohols, aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of alcohols may include ethanol, isopropyl alcohol, butyl alcohol, and benzyl alcohol. Other specific examples include tripropylene glycol methyl ether, tripropylene glycol n-butyl ether, 2-ethyl-2-(hydroxymethyl)-1,3-propane diol (EPHD), 2-methyl-1,3-propanediol, 1,2-butanediol, dimethyl sulfoxide, sulfolane, and/or alkyldiols such as 1,2-hexanediol.

The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2-hexanediol, 1,2,6-hexanetriol, glycerin, trimethylolpropane, and xylitol. Examples of polyhydric alcohol derivatives may include an ethylene oxide adduct of diglycerin.

The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

An anti-kogation agent may also be included in the vehicle of a thermal inkjet formulation. Kogation refers to the deposit of dried printing liquid (e.g., dried thermal inkjet fluid composition) on a heating element of a thermal inkjet printhead. Anti-kogation agent(s) is/are included to assist in preventing the buildup of kogation. In some examples, the anti-kogation agent may improve the jettability of the thermal inkjet fluid composition. The anti-kogation agent may be present in the thermal inkjet fluid composition in an amount ranging from about 0.1 wt % active to about 1.5 wt % active, based on the total weight of the thermal inkjet fluid composition. In an example, the anti-kogation agent is present in the thermal inkjet fluid composition in an amount of about 0.5 wt % active, based on the total weight of the thermal inkjet fluid composition.

Examples of suitable anti-kogation agents include oleth-3-phosphate (commercially available as CRODAFOS™ O3A or CRODAFOS™ N-3A) or dextran 500 k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc.

The vehicle may include anti-decel agent(s). Decel refers to a decrease in drop velocity over time with continuous firing. Anti-decel agent(s) is/are included to assist in preventing decel. In some examples, the anti-decel agent may improve the jettability of the thermal inkjet fluid composition. The anti-decel agent may be present in an amount ranging from about 0.2 wt % active to about 5 wt % active (based on the total weight of the thermal inkjet fluid composition). In an example, the anti-decel agent is present in the thermal inkjet fluid composition in an amount of about 1 wt % active, based on the total weight of the thermal inkjet fluid composition.

An example of a suitable anti-decel agent is ethoxylated glycerin having the following formula:

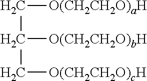

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

The vehicle of the thermal inkjet fluid composition may also include surfactant(s). In any of the examples disclosed herein, the surfactant may be present in an amount ranging from about 0.01 wt % active to about 5 wt % active (based on the total weight of the thermal inkjet fluid composition). In an example, the surfactant is present in the thermal inkjet fluid composition in an amount ranging from about 0.05 wt % active to about 3 wt % active, based on the total weight of the thermal inkjet fluid composition.

The surfactant may include anionic and/or non-ionic surfactants. Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsulfonate, and dibutylphenylphenol disulfonate. Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a siloxane surfactant or a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In some examples, the vehicle may include a silicone-free alkoxylated alcohol surfactant such as, for example, TEGO® Wet 510 (EvonikTegoChemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSO (a.k.a. CAPSTONE®, which is a water-soluble, ethoxylated non-ionic fluorosurfactant from Dupont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Co.).

The chelating agent is another example of an additive that may be included in the aqueous vehicle. When included, the chelating agent is present in an amount greater than 0 wt % active and less than or equal to 0.5 wt % active based on the total weight of the thermal inkjet fluid composition. In an example, the chelating agent is present in an amount ranging from about 0.05 wt % active to about 0.2 wt % active based on the total weight of the thermal inkjet fluid composition.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

The vehicle may also include biocide(s) (i.e., antimicrobial agents). In an example, the total amount of biocide(s) in the thermal inkjet fluid composition ranges from about 0.1 wt % active to about 0.25 wt % active (based on the total weight of the thermal inkjet fluid composition). In another example, the total amount of biocide(s) in the thermal inkjet fluid composition is about 0.22 wt % active (based on the total weight of the thermal inkjet fluid composition).

Examples of suitable biocides include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

The vehicle may also include a pH adjuster. A pH adjuster may be included in the thermal inkjet fluid composition to achieve a desired pH (e.g., a pH of about 8.5) and/or to counteract any slight pH drop that may occur over time. In an example, the total amount of pH adjuster(s) in the thermal inkjet fluid composition ranges from greater than 0 wt % to about 0.1 wt % (based on the total weight of the thermal inkjet fluid composition). In another example, the total amount of pH adjuster(s) in the thermal inkjet fluid composition is about 0.03 wt % (based on the total weight of the thermal inkjet fluid composition).

Examples of suitable pH adjusters include metal hydroxide bases, such as potassium hydroxide (KOH), sodium hydroxide (NaOH), etc. In an example, the metal hydroxide base may be added to the thermal inkjet fluid composition in an aqueous solution. In another example, the metal hydroxide base may be added to the thermal inkjet fluid composition in an aqueous solution including 5 wt % of the metal hydroxide base (e.g., a 5 wt % potassium hydroxide aqueous solution).

In some examples of the thermal inkjet fluid composition, the initial pH is 7 or higher. In other examples of the thermal inkjet fluid composition, the initial pH is 8 or higher. In yet other examples, the thermal inkjet fluid composition may have an initial pH from pH 8 to pH 11, from pH 8 to pH 10, from pH 8.2 to pH 10, from pH 8.5 to pH 10, from pH 8 to pH 9, from pH 8.2 to pH 9, from pH 8.5 to pH 9, from pH 8 to pH 8.5, of from pH 8.2 to pH 8.5. In still other examples, the thermal inkjet fluid composition may have an initial pH of about 8.5.

Thermal Inkjet Ink Compositions

As mentioned above, in some examples, the thermal inkjet fluid composition is an ink, and further comprises an anionic pigment.

Anionic Pigments

The anionic pigment included in the thermal inkjet ink composition may be any anionic pigment. In some examples, the pigment may be incorporated into the ink composition as a pigment dispersion. The pigment dispersion may include a pigment and a separate dispersant, or may include a self-dispersed pigment. The phrase “anionic pigment” means that the pigment and/or the pigment dispersant is/are anionic (i.e., negatively charged).

For the anionic pigment dispersions disclosed herein, it is to be understood that the pigment and separate dispersant or the self-dispersed pigment (prior to being incorporated into the ink formulation), may be dispersed in water alone or in combination with an additional water soluble or water miscible co-solvent, such as those described for the binder dispersion. It is to be understood however, that the liquid components of the anionic pigment dispersion become part of the aqueous vehicle in the ink composition.

Whether separately dispersed or self-dispersed, the pigment can be any of a number of primary or secondary colors, or black or white. As specific examples, the pigment may be any color, including, as examples, a cyan pigment, a magenta pigment, a yellow pigment, a black pigment, a violet pigment, a green pigment, a brown pigment, an orange pigment, a purple pigment, a white pigment, or combinations thereof.

Pigments and Separate Dispersants

Examples of the ink composition may include a pigment that is not self-dispersing and a separate dispersant. Examples of these pigments, as well as suitable dispersants for these pigments will now be described.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50. Any quinacridone pigment or a co-crystal of quinacridone pigments may be used for magenta inks.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 155, C.I. Pigment Yellow 167, C.I. Pigment Yellow 172, C.I. Pigment Yellow 180, C.I. Pigment Yellow 185, and C.I. Pigment Yellow 213.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, BLACK PEARLS® series, the MOGUL® series, or the MONARCH® series manufactured by Cabot Corporation, Boston, Mass., (such as, e.g., REGAL® 400R, REGAL® 330R, REGAL® 660R, BLACK PEARLS® 700, BLACK PEARLS® 800, BLACK PEARLS® 880, BLACK PEARLS® 1100, BLACK PEARLS® 4350, BLACK PEARLS® 4750, MOGUL® E, MOGUL® L, and ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® 75, PRINTEX® 80, PRINTEX® 85, PRINTEX® 90, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 64, C.I. Pigment Orange 66, C.I. Pigment Orange 71, and C.I. Pigment Orange 73.

The average particle size of the pigments may range anywhere from about 20 nm to about 200 nm. In an example, the average particle size ranges from about 80 nm to about 150 nm.

Any of the pigments mentioned herein can be dispersed by a separate dispersant, such as a styrene (meth)acrylate dispersant, or another dispersant suitable for keeping the pigment suspended in the aqueous vehicle. For example, the dispersant can be any dispersing (meth)acrylate polymer, or other type of polymer, such as a maleic polymer or a dispersant with aromatic groups and a poly(ethylene oxide) chain.

In one example, (meth)acrylate polymer can be a styrene-acrylic type dispersant polymer, as it can promote π-stacking between the aromatic ring of the dispersant and various types of pigments, such as copper phthalocyanine pigments, for example. In one example, the styrene-acrylic dispersant can have a weight average molecular weight (M_{w}) ranging from about 4,000 to about 30,000. In another example, the styrene-acrylic dispersant can have a weight average molecular weight ranging from about 8,000 to about 28,000, from about 12,000 to about 25,000, from about 15,000 to about 25,000, from about 15,000 to about 20,000, or about 17,000. Regarding the acid number, the styrene-acrylic dispersant can have an acid number from 100 to 350, from 120 to 350, from 150 to 250, from 155 to 185, or about 172, for example. Example commercially available styrene-acrylic dispersants can include JONCRYL® 671, JONCRYL® 71, JONCRYL® 96, JONCRYL® 680, JONCRYL® 683, JONCRYL® 678, JONCRYL® 690, JONCRYL® 296, JONCRYL® 696 or JONCRYL® ECO 675 (all available from BASF Corp.).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). Also, in some examples, the terms “(meth)acrylate” and “(meth)acrylic acid” can be used interchangeably, as acrylates and methacrylates are salts and esters of acrylic acid and methacrylic acid, respectively. Furthermore, mention of one compound over another can be a function of pH. For examples, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylic acid or as (meth)acrylate should not be read so rigidly as to not consider relative pH levels, ester chemistry, and other general organic chemistry concepts.

The following are some example pigment and separate dispersant combinations: a carbon black pigment with a styrene acrylic dispersant; PB 15:3 (cyan pigment) with a styrene acrylic dispersant; PR122 (magenta) or a co-crystal of PR122 and PV19 (magenta) with a styrene acrylic dispersant; or PY74 (yellow) or PY155 (yellow) with a styrene acrylic dispersant.

In an example, the pigment is present in the ink composition in an amount ranging from about 1 wt % active to about 6 wt % active of the total weight of the ink composition. In another example, the pigment is present in the ink composition in an amount ranging from about 2 wt % active to about 6 wt % active of the total weight of the ink composition. When the separate dispersant is used, the separate dispersant may be present in an amount ranging from about 0.05 wt % active to about 6 wt % active of the total weight of the ink composition. In some examples, the ratio of pigment to separate dispersant may range from 0.1 (1:10) to 1 (1:1).

Self-Dispersed Pigments

In other examples, the ink composition includes a self-dispersed pigment, which includes a pigment and an organic group attached thereto.

Any of the pigments set forth herein may be used, such as carbon, phthalocyanine, quinacridone, azo, or any other type of organic pigment, as long as at least one organic group that is capable of dispersing the pigment is attached to the pigment.

The organic group that is attached to the pigment includes at least one aromatic group, an alkyl (e.g., C₁ to C₂₀), and an ionic or ionizable group.

The aromatic group may be an unsaturated cyclic hydrocarbon containing one or more rings and may be substituted or unsubstituted, for example with alkyl groups. Aromatic groups include aryl groups (for example, phenyl, naphthyl, anthracenyl, and the like) and heteroaryl groups (for example, imidazolyl, pyrazolyl, pyridinyl, thienyl, thiazolyl, furyl, triazinyl, indolyl, and the like).

The alkyl may be branched or unbranched, substituted or unsubstituted.

The ionic or ionizable group may be at least one phosphorus-containing group, at least one sulfur-containing group, or at least one carboxylic acid group.

In an example, the at least one phosphorus-containing group has at least one P—O bond or P═O bond, such as at least one phosphonic acid group, at least one phosphinic acid group, at least one phosphinous acid group, at least one phosphite group, at least one phosphate, diphosphate, triphosphate, or pyrophosphate groups, partial esters thereof, or salts thereof. By “partial ester thereof”, it is meant that the phosphorus-containing group may be a salt of a partial phosphonic acid ester group, the partial phosphonic acid ester group having the formula —PO₃RH, wherein R is an aryl, alkaryl, aralkyl, or alkyl group. By “salts thereof”, it is meant that the phosphorus-containing group may be in a partially or fully ionized form having a cationic counterion.

When the organic group includes at least two phosphonic acid groups or salts thereof, either or both of the phosphonic acid groups may be a partial phosphonic ester group. Also, one of the phosphonic acid groups may be a phosphonic acid ester having the formula —PO₃R₂, while the other phosphonic acid group may be a partial phosphonic ester group, a phosphonic acid group, or a salt thereof. In some instances, it may be desirable that at least one of the phosphonic acid groups is either a phosphonic acid, a partial ester thereof, or salts thereof. When the organic group includes at least two phosphonic acid groups, either or both of the phosphonic acid groups may be in either a partially or fully ionized form. In these examples, either or both of the phosphonic acid groups may have the formula —PO₃H₂, —PO₃H⁻M⁺ (monobasic salt), or —PO₃⁻²M⁺² (dibasic salt), wherein M⁺ is a cation such as Na⁺, K⁺, Li⁺, or NR₄⁺, wherein R, which can be the same or different, represents hydrogen or an organic group such as a substituted or unsubstituted aryl and/or alkyl group.

As other examples, the organic group may include at least one geminal bisphosphonic acid group, partial esters thereof, or salts thereof. By “geminal”, it is meant that the at least two phosphonic acid groups, partial esters thereof, or salts thereof are directly bonded to the same carbon atom. Such a group may also be referred to as a 1,1-diphosphonic acid group, partial ester thereof, or salt thereof.

An example of a geminal bisphosphonic acid group may have the formula —CQ(PO₃H₂)₂. Q is bonded to the geminal position and may be H, R, OR, SR, or NR₂ wherein R, which can be the same or different when multiple are present, is selected from H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. For examples, Q may be H, R, OR, SR, or NR₂, wherein R, which can be the same or different when multiple are present, is selected from H, a C₁-C₆ alkyl group, or an aryl group. As specific examples, Q is H, OH, or NH₂. Another example of a geminal bisphosphonic acid group may have the formula —(CH₂)ₙCQ(PO₃H₂)₂, or may be partial esters thereof or salts thereof, wherein Q is as described above and n is 0 to 9, such as 1 to 9. In some specific examples, n is 0 to 3, such as 1 to 3, or n is either 0 or 1.

Still another example of a geminal bisphosphonic acid group may have the formula —X—(CH₂)ₙCQ(PO₃H₂)₂, or may be partial esters thereof or salts thereof, wherein Q and n are as described above and X is an arylene, heteroarylene, alkylene, vinylidene, alkarylene, aralkylene, cyclic, or heterocyclic group. In specific examples, X is an arylene group, such as a phenylene, naphthalene, or biphenylene group, which may be further substituted with any group, such as one or more alkyl groups or aryl groups. When X is an alkylene group, examples include substituted or unsubstituted alkylene groups, which may be branched or unbranched and can be substituted with one or more groups, such as aromatic groups. Examples of X include C₁-C₁₂ groups like methylene, ethylene, propylene, or butylene. X may be directly attached to the pigment, meaning there are no additional atoms or groups from the attached organic group between the pigment and X. X may also be further substituted with one or more functional groups. Examples of functional groups include R′, OR′, COR′, COOR′, OCOR′, carboxylates, halogens, CN, NR′₂, SO₃H, sulfonates, sulfates, NR′(COR′), CONR′₂, imides, NO₂, phosphates, phosphonates, N═NR′, SOR′, NR′SO₂R′, and SO₂NR′₂, wherein R′, which can be the same or different when multiple are present, is independently selected from hydrogen, branched or unbranched C₁-C₂₀ substituted or unsubstituted, saturated or unsaturated hydrocarbons, e.g., alkyl, alkenyl, alkynyl, substituted or unsubstituted aryl, substituted or unsubstituted heteroaryl, substituted or unsubstituted alkaryl, or substituted or unsubstituted aralkyl.

Yet another example of a geminal bisphosphonic acid group may have the formula —X-Sp-(CH₂)ₙCQ(PO₃H₂)₂, or may be partial esters thereof or salts thereof, wherein X, Q, and n are as described above. “Sp” is a spacer group, which, as used herein, is a link between two groups. Sp can be a bond or a chemical group. Examples of chemical groups include, but are not limited to, —CO₂—, —O₂C—, —CO—, —OSO₂—, —SO₃—, —SO₂—, —SO₂C₂H₄O—, —SO₂C₂H₄S—, —SO₂C₂H₄NR″—, —O—, —S—, —NR″—, —NR″CO—, —CONR″—, —NR″CO₂—, —O₂CNR″—, —NR″CONR″—, —N(COR″)CO—, —CON(COR″)—, —NR″COCH(CH₂CO₂R″)— and cyclic imides therefrom, —NR″COCH₂CH(CO₂R″)— and cyclic imides therefrom, —CH(CH₂CO₂R″)CONR″— and cyclic imides therefrom, —CH(CO₂R″)CH₂CONR″ and cyclic imides therefrom (including phthalimide and maleimides of these), sulfonamide groups (including —SO₂NR″— and —NR″SO₂— groups), arylene groups, alkylene groups and the like. R″, which can be the same or different when multiple are included, represents H or an organic group such as a substituted or unsubstituted aryl or alkyl group. In the example formula —X-Sp-(CH₂)ₙCQ(PO₃H₂)₂, the two phosphonic acid groups or partial esters or salts thereof are bonded to X through the spacer group Sp. Sp may be —CO₂—, —O₂C—, —O—, —NR″—, —NR″CO—, or —CONR″—, —SO₂NR″—, —SO₂CH₂CH₂NR″—, —SO₂CH₂CH₂O—, or —SO₂CH₂CH₂S— wherein R″ is H or a C₁-C₆ alkyl group.

Still a further example of a geminal bisphosphonic acid group may have the formula —N—[(CH₂)ₘ(PO₃H₂)]₂, partial esters thereof, or salts thereof, wherein m, which can be the same or different, is 1 to 9. In specific examples, m is 1 to 3, or 1 or 2. As another example, the organic group may include at least one group having the formula —(CH₂)n-N—[(CH₂)ₘ(PO₃H₂)]₂, partial esters thereof, or salts thereof, wherein n is 0 to 9, such as 1 to 9, or 0 to 3, such as 1 to 3, and m is as defined above. Also, the organic group may include at least one group having the formula —X—(CH₂)ₙ—N—[(CH₂)ₘ(PO₃H₂)]₂, partial esters thereof, or salts thereof, wherein X, m, and n are as described above, and, in an example, X is an arylene group. Still further, the organic group may include at least one group having the formula —X-Sp-(CH₂)ₙ—N—[(CH₂)ₘ(PO₃H₂)]₂, partial esters thereof, or salts thereof, wherein X, m, n, and Sp are as described above.

Yet a further example of a geminal bisphosphonic acid group may have the formula —CR═C(PO₃H₂)₂, partial esters thereof, or salts thereof. In this example, R can be H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. In an example, R is H, a C₁-C₆ alkyl group, or an aryl group.

The organic group may also include more than two phosphonic acid groups, partial esters thereof, or salts thereof, and may, for example include more than one type of group (such as two or more) in which each type of group includes at least two phosphonic acid groups, partial esters thereof, or salts thereof. For example, the organic group may include a group having the formula —X—[CQ(PO₃H₂)₂]_{P}, partial esters thereof, or salts thereof. In this example, X and Q are as described above. In this formula, p is 1 to 4, e.g., 2.

In addition, the organic group may include at least one vicinal bisphosphonic acid group, partial ester thereof, or salts thereof, meaning that these groups are adjacent to each other. Thus, the organic group may include two phosphonic acid groups, partial esters thereof, or salts thereof bonded to adjacent or neighboring carbon atoms. Such groups are also sometimes referred to as 1,2-diphosphonic acid groups, partial esters thereof, or salts thereof. The organic group including the two phosphonic acid groups, partial esters thereof, or salts thereof may be an aromatic group or an alkyl group, and therefore the vicinal bisphosphonic acid group may be a vicinal alkyl or a vicinal aryl diphosphonic acid group, partial ester thereof, or salt thereof. For example, the organic group may be a group having the formula —C₆H₃—(PO₃H₂)₂, partial esters thereof, or salts thereof, wherein the acid, ester, or salt groups are in positions ortho to each other.

In other examples, the ionic or ionizable group (of the organic group attached to the pigment) is a sulfur-containing group. The at least one sulfur-containing group has at least one S═O bond, such as a sulfinic acid group or a sulfonic acid group. Salts of sulfinic or sulfonic acids may also be used, such as —SO₃⁻X⁺, where X is a cation, such as Na⁺, H⁺, K⁺, NH₄⁺, Li⁺, Ca²⁺, Mg⁺, etc.

When the ionic or ionizable group is a carboxylic acid group, the group may be COOH or a salt thereof, such as —COO⁻X⁺, —(COO⁻X⁺)₂, or —(COO⁻X⁺)₃.

Furthermore, it is to be understood that mention of one compound or another (acid or salt) can be a function of pH. For example, if an acid were used during preparation of the self-dispersed pigment, pH modifications during preparation or subsequently when added to the ink composition can impact the nature of the moiety as well (acid form vs. salt form). Thus, an acid described as carboxylic acid should not be read so rigidly as to not consider relative pH levels, acid dissociation, and other general chemistry concepts.

Examples of the self-dispersed pigments are commercially available as dispersions. Suitable commercially available self-dispersed pigment dispersions include those of the CAB-O-JET® 200 Series, manufactured by Cabot Corporation. Some specific examples include CAB-O-JET® 200 (black pigment), CAB-O-JET® 250C (cyan pigment), CAB-O-JET® 260M or 265M (magenta pigment) and CAB-O-JET®270 (yellow pigment)). Other suitable commercially available self-dispersed pigment dispersions include those of the CAB-O-JET® 400 Series, manufactured by Cabot Corporation. Some specific examples include CAB-O-JET® 400 (black pigment), CAB-O-JET® 450C (cyan pigment), CAB-O-JET® 465M (magenta pigment) and CAB-O-JET® 470Y (yellow pigment)). Still other suitable commercially available self-dispersed pigment dispersions include those of the CAB-O-JET® 300 Series, manufactured by Cabot Corporation. Some specific examples include CAB-O-JET® 300 (black pigment) and CAB-O-JET® 352K (black pigment).

The self-dispersed pigment is present in an amount ranging from about 1 wt % active to about 6 wt % active based on a total weight of the ink composition. In an example, the dispersed pigment is present in an amount ranging from about 2 wt % active to about 5 wt % active based on a total weight of the ink composition. In another example, the self-dispersed pigment is present in an amount of about 3 wt % based on the total weight of the ink composition. In still another example, the self-dispersed pigment is present in an amount of about 5 wt % active based on the total weight of the ink composition.

Thermal Inkjet Overcoat Compositions

As mentioned above, in some examples, the thermal inkjet fluid composition is an overcoat composition that is substantially colorless. The phrase “substantially colorless” means that the overcoat composition is achromatic and does not include a colorant. In some examples, the overcoat composition may also be clear. As used herein, “clear,” means that 80% or more of visible light (i.e., light with a wavelength ranging from 390 nm to 700 nm) can be transmitted through the overcoat composition.

When the thermal inkjet fluid composition is an overcoat composition, the thermal inkjet fluid composition may be used with a separate thermal inkjet ink composition. In these examples, the separate ink composition may include an anionic pigment dispersion, a polymeric binder, and an aqueous vehicle (each of which is described above).

Substrates

The thermal inkjet fluid composition can be applied on a broad selection of substrates. For example, the thermal inkjet fluid composition may be applied on flexible as well as rigid substrates, and porous or non-porous substrates. Some examples include paper (e.g., plain paper, coated, glossy paper, etc.), cardboard, foam board, untreated plastic, textile, and others.

Printing Methods

In some examples of the printing method disclosed herein, the thermal inkjet fluid composition is a thermal inkjet ink composition. These examples of the printing method will be further described in reference to FIG. 2.

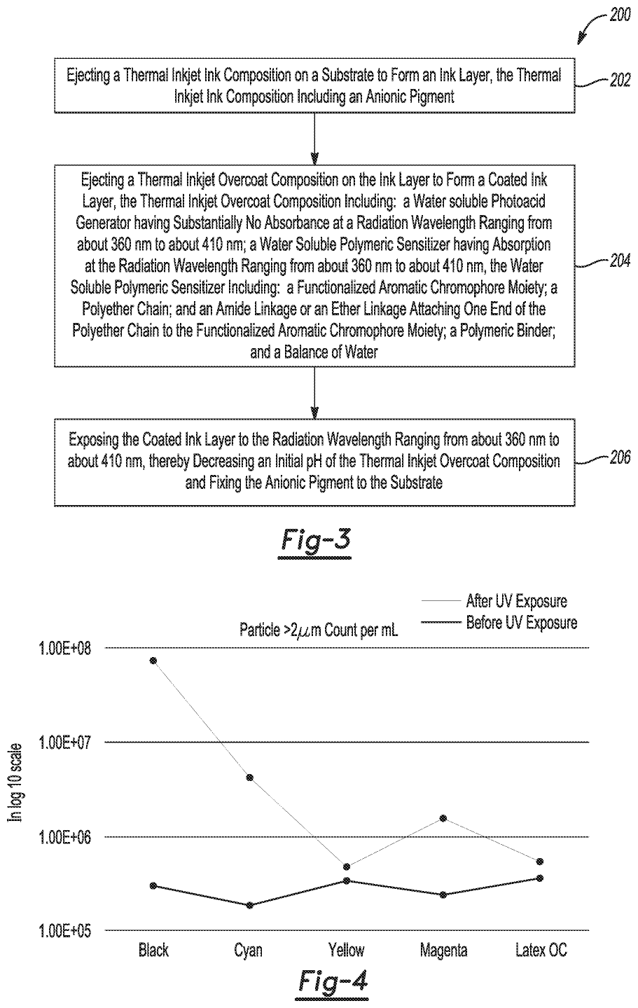

In some other examples of the printing method disclosed herein, the thermal inkjet fluid composition is a thermal inkjet overcoat composition. These examples of the printing method will be further described in reference to FIG. 3.

Printing with Thermal Inkjet Ink Composition

FIG. 2 depicts an example of the printing method 100. As shown in FIG. 2, an example the printing method 100 comprises: ejecting a thermal inkjet ink composition on a substrate to form an ink layer, the thermal inkjet ink composition including: a water soluble photoacid generator having substantially no absorbance at a radiation wavelength ranging from about 360 nm to about 410 nm; a water soluble polymeric sensitizer having absorption at the radiation wavelength ranging from about 360 nm to about 410 nm, the water soluble polymeric sensitizer including: a functionalized aromatic chromophore moiety; a polyether chain; and an amide linkage or an ether linkage attaching one end of the polyether chain to the functionalized aromatic chromophore moiety; a polymeric binder; an anionic pigment; and a balance of water (reference numeral 102); and exposing the ink layer to the radiation wavelength ranging from about 360 nm to about 410 nm, thereby decreasing an initial pH of the thermal inkjet ink composition and fixing the anionic pigment to the substrate (reference numeral 104).

It is to be understood that any example of the thermal inkjet fluid composition that includes the anionic pigment may be used as the thermal inkjet ink composition in the examples of the method 100. It is also to be understood that any example of the substrate may also be used in the examples of the method 100.

In some examples, multiple thermal inkjet ink compositions may be ejected onto the substrate. In these examples, each of the thermal inkjet ink compositions may include the water soluble photoacid generator, the water soluble polymeric sensitizer, the polymeric binder, the anionic pigment, and the aqueous vehicle. However, each of the thermal inkjet ink compositions may include different a different anionic pigment so that a different color (e.g., cyan, magenta, yellow, black, violet, green, brown, orange, purple, white, etc.) is generated by each of the thermal inkjet ink compositions. As an example, a combination of two or more thermal inkjet ink compositions selected from the group consisting of a cyan ink composition, a magenta ink composition, a yellow ink composition, and a black ink composition may be ejected onto the substrate.

In other examples, a single thermal inkjet ink composition may be ejected onto the substrate.

The thermal inkjet ink composition(s) may be ejected onto the substrate using any suitable applicator, such as a thermal inkjet printhead, a piezoelectric printhead, a continuous inkjet printhead, etc. The applicator may eject the thermal inkjet ink composition(s) in a single pass or in multiple passes. As an example of single pass printing, the cartridge(s) of an inkjet printer deposit the desired amount of the ink composition(s) during the same pass of the cartridge(s) across the substrate. In other examples, the cartridge(s) of an inkjet printer deposit the desired amount of the ink composition(s) over several passes of the cartridge(s) across the substrate.

In the method 100, the exposing of the ink layer to the radiation wavelength may be accomplished with a radiation source. In an example, the radiation source may be a light emitting diode having an emission wavelength ranging from 360 nm to about 410 nm. In another example, the radiation source may be a narrow wavelength ultraviolet light source. In still another example of the method 100, the exposing of the ink layer is accomplished with a narrow wavelength ultraviolet light source having an emission wavelength of 365 nm, 375 nm, 385 nm, 395 nm or 405 nm. In yet another example, the radiation source may be a 395 nm light emitting diode.

In an example, the exposing of the ink layer to the radiation wavelength may be for a time period ranging from about 0.01 seconds to about 30 seconds. In another example, the exposing of the ink layer to the radiation wavelength may be for a time period ranging from about 0.1 seconds to about 20 seconds. In still another example, the exposing of the ink layer to the radiation wavelength may be for a time period ranging from about 0.1 seconds to about 5 seconds. In yet another example, the exposing of the ink layer to the radiation wavelength may be for a time period of about 15 seconds.

It is to be understood that the exposing of the ink layer to the radiation wavelength may be accomplished using a single continuous pulse exposure of radiation, or a multiple pulsing mode of radiation exposure.

In multiple pulsing mode examples, the exposure time during each of the individual pulses of radiation may be added to calculate a total exposure time. Examples of this total exposure time fall within the example time period ranges disclosed above.

When the ink layer is exposed to the radiation wavelength ranging from about 360 nm to about 410 nm, the water soluble polymeric sensitizer in the ink layer absorbs the energy and transfers it to the water soluble photoacid generator in the ink layer. This causes the water soluble photoacid generator to break down, which generates H⁺, thereby decreasing an initial pH of the thermal inkjet ink composition.

The pH of the thermal inkjet ink composition, after exposure to the radiation wavelength ranging from about 360 nm to about 410 nm, may depend, at least in part, on the initial pH of the thermal inkjet ink composition. In an example, the pH of the thermal inkjet ink composition, after exposure to the radiation wavelength ranging from about 360 nm to about 410 nm, may be lower than 8. In another example, the pH of the thermal inkjet ink composition, after radiation exposure, may be about 7.5 or lower. In still another example, the pH of the thermal inkjet ink composition, after radiation exposure, may be lower than 7.

The generation of H⁺ and decrease in pH destabilizes the anionic pigment in the ink layer. The generation of H⁺ and decrease in pH may also destabilize the polymeric binder in the ink layer (e.g., when the polymeric binder is anionic). This destabilization (of the anionic pigment and/or the polymeric binder) fixes the anionic pigment to the substrate. As such, exposing the ink layer to the radiation wavelength ranging from about 360 nm to about 410 nm decreases an initial pH of the thermal inkjet ink composition and fixes the anionic pigment to the substrate.

Printing with Thermal Inkjet Overcoat Composition

FIG. 3 depicts an example of the printing method 200. As shown in FIG. 3, an example the printing method 200 comprises: ejecting a thermal inkjet ink composition on a substrate to form an ink layer, the thermal inkjet ink composition including an anionic pigment (reference numeral 202); ejecting a thermal inkjet overcoat composition on the ink layer to form a coated ink layer, the thermal inkjet overcoat composition including: a water soluble photoacid generator having substantially no absorbance at a radiation wavelength ranging from about 360 nm to about 410 nm; a water soluble polymeric sensitizer having absorption at the radiation wavelength ranging from about 360 nm to about 410 nm, the water soluble polymeric sensitizer including: a functionalized aromatic chromophore moiety; a polyether chain; and an amide linkage or an ether linkage attaching one end of the polyether chain to the functionalized aromatic chromophore moiety; a polymeric binder; and a balance of water (reference numeral 204); and exposing the coated ink layer to the radiation wavelength ranging from about 360 nm to about 410 nm, thereby decreasing an initial pH of the thermal inkjet overcoat composition and fixing the anionic pigment to the substrate (reference numeral 206).

It is to be understood that any example of the thermal inkjet fluid composition that excludes the anionic pigment may be used as the thermal inkjet overcoat composition in the examples of the method 200. It is also to be understood that any thermal inkjet ink composition including an anionic pigment may be used in the examples of the method 200. Further, it is to be understood that any example of the substrate may also be used in the examples of the method 200.

In some examples, multiple thermal inkjet ink compositions may be ejected onto the substrate. In these examples, each of the thermal inkjet ink compositions may include the polymeric binder, the anionic pigment, and the aqueous vehicle. However, each of the thermal inkjet ink compositions may include different a different anionic pigment so that a different color (e.g., cyan, magenta, yellow, black, violet, green, brown, orange, purple, white, etc.) is generated by each of the thermal inkjet ink compositions. As an example, a combination of two or more thermal inkjet ink compositions selected from the group consisting of a cyan ink composition, a magenta ink composition, a yellow ink composition, and a black ink composition may be ejected onto the substrate.

In other examples, a single thermal inkjet ink composition may be ejected onto the substrate.

The thermal inkjet ink composition(s) may be ejected onto the substrate using any suitable applicator, such as a thermal inkjet printhead, a piezoelectric printhead, a continuous inkjet printhead, etc. The applicator may eject the thermal inkjet ink composition(s) in a single pass or in multiple passes.

Similarly, the thermal inkjet overcoat composition may be ejected onto the ink layer using any suitable applicator, such as a thermal inkjet printhead, a piezoelectric printhead, a continuous inkjet printhead, etc. The applicator may eject the thermal inkjet overcoat composition in a single pass or in multiple passes.

In the method 200, the exposing of the coated ink layer to the radiation wavelength may be accomplished with a radiation source. In an example, the radiation source may be a light emitting diode having an emission wavelength ranging from 360 nm to about 410 nm. In another example, the radiation source may be a narrow wavelength ultraviolet light source. In still another example of the method 200, the exposing of the coated ink layer is accomplished with a narrow wavelength ultraviolet light source having an emission wavelength of 365 nm, 375 nm, 385 nm, 395 nm or 405 nm. In yet another example, the radiation source may be a 395 nm light emitting diode.

In an example, the exposing of the coated ink layer to the radiation wavelength may be for a time period ranging from about 0.01 seconds to about 30 seconds. In another example, the exposing of the coated ink layer to the radiation wavelength may be for a time period ranging from about 0.1 seconds to about 20 seconds. In still another example, the exposing of the coated ink layer to the radiation wavelength may be for a time period ranging from about 0.1 seconds to about 5 seconds. In yet another example, the exposing of the coated ink layer to the radiation wavelength may be for a time period of about 15 seconds.

It is to be understood that the exposing of the coated ink layer to the radiation wavelength may be accomplished using a single continuous pulse exposure of radiation, or a multiple pulsing mode of radiation exposure.

In multiple pulsing mode examples, the exposure time during each of the individual pulses of radiation may be added to calculate a total exposure time. Examples of this total exposure time fall within the example time period ranges disclosed above.

When the coated ink layer is exposed to the radiation wavelength ranging from about 360 nm to about 410 nm, the water soluble polymeric sensitizer in the coated ink layer absorbs the energy and transfers it to the water soluble coated photoacid generator in the coated ink layer. This causes the water soluble photoacid generator to break down, which generates H⁺, thereby decreasing an initial pH of the thermal inkjet overcoat composition.

The pH of the thermal inkjet overcoat composition, after exposure to the radiation wavelength ranging from about 360 nm to about 410 nm, may depend, at least in part, on the initial pH of the thermal inkjet overcoat composition. In an example, the pH of the thermal inkjet overcoat composition, after exposure to the radiation wavelength ranging from about 360 nm to about 410 nm, may be lower than 8. In another example, the pH of the thermal inkjet overcoat composition, after radiation exposure, may be about 7.5 or lower. In still another example, the pH of the thermal inkjet overcoat composition, after radiation exposure, may be about 7 or lower. In yet another example, the pH of the thermal inkjet overcoat composition, after radiation exposure, may be lower than 7.

The generation of H⁺ and decrease in pH destabilizes the anionic pigment in the coated ink layer. The generation of H⁺ and decrease in pH may also destabilize the polymeric binder(s) in the coated ink layer (e.g., when the polymeric binder is anionic). This destabilization (of the anionic pigment and/or the polymeric binder(s)) fixes the anionic pigment to the substrate. As such, exposing the coated ink layer to the radiation wavelength ranging from about 360 nm to about 410 nm decreases an initial pH of the thermal inkjet overcoat composition and fixes the anionic pigment to the substrate.

To further illustrate the present disclosure, an example is given herein. It is to be understood that this example is provided for illustrative purposes and is not to be construed as limiting the scope of the present disclosure.

### Example

In this example, a black ink, a cyan ink, a yellow ink, a magenta ink, and an overcoat composition were prepared in accordance with the examples disclosed herein. A 60% stock vehicle was used in each of these compositions, and the composition of the stock vehicle is shown in Table 1. The ink and overcoat compositions are shown in Table 2. The final pH of the 60% stock vehicle was adjusted with dilute aqueous potassium hydroxide (KOH) to 6±1, the final pH of the ink compositions was adjusted with the dilute aqueous KOH to 8.5±0.5, and the final pH of the overcoat composition was adjusted with the dilute aqueous KOH to 8.5±0.5.

TABLE 1

| 60% Stock | | |
|---|---|---|
| Vehicle | | Weight |
| Component | Specific Component | Percent |
| Co-solvent | 1,2-butanediol | 7.50 |
| | 2-pyrrolidone | 1.50 |
| | Tripropylene Glycol Methyl Ether | 1.00 |
| | Tripropylene Glycol n-Butyl Ether | 0.35 |
| Anti-kogation | Oleth-3-phosphate | 0.50 |
| agent | | |
| Surfactant | Non-ionic surfactant | 0.20 |
| | Siloxane surfactant | 0.80 |
| Polymeric sensitizer | 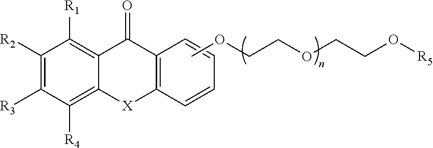 I wherein R₁-R₄ = H; R₅ = Me, X = S; and n = 11 | 4.00 |
| Photoacid | Diphenyl iodonium nitrate | 2.00 |
| Generator | | |
| Water | | 42.15 |

TABLE 2

| | Black | Cyan | Yellow | Magenta | |
|---|---|---|---|---|---|
| Ink/Overcoat | Ink | Ink | Ink | Ink | Overcoat |
| Component | (grams) | (grams) | (grams) | (grams) | (grams) |
| Black pigment | 15 | — | — | — | — |
| dispersion | | | | | |
| Cyan pigment | — | 15 | — | — | — |
| dispersion | | | | | |
| Yellow pigment | — | — | 15 | — | — |
| dispersion | | | | | |
| Magenta pigment | — | — | — | 15 | — |
| dispersion | | | | | |
| 60% Stock vehicle | 60 | 60 | 60 | 60 | 60 |
| Acrylic latex binder | 25 | 25 | 25 | 25 | 25 |
| Water | — | — | — | — | 15 |

Each of the ink compositions and the overcoat composition was placed into a tube. The tubes were positioned within a sample enclosure and exposed to ultraviolet radiation from a 395 nm UV LED array for 15 seconds. The 60% stock vehicle and a comparative 60% stock vehicle (e.g., the same composition as shown in Table 1 without the photoacid generator and with 44.15% water) were also placed into respective tubes and exposed to ultraviolet radiation in the same manner.

The pH before UV exposure and after UV exposure for the ink compositions, the overcoat composition, the 60% stock vehicle, the comparative 60% stock vehicle were measured and are shown in Table 3. The ink compositions and the overcoat composition were also visually inspected for pigment precipitation. In Table 3, “Yes” means that pigment precipitation was observed, and N/A means “not applicable” because the formulations did not include any pigment.

TABLE 3

| | | | | | | | Comp. |
|---|---|---|---|---|---|---|---|
| | | | | | | 60% | 60% |
| | Black | Cyan | Yellow | Magenta | Over- | Stock | Stock |
| | Ink | Ink | Ink | Ink | coat | Vehicle | Vehicle |
| pH Before | 8.44 | 8.46 | 8.52 | 8.47 | 8.63 | 6.43 | 5.07 |
| UV | | | | | | | |
| exposure | | | | | | | |
| pH After | 7.47 | 7.61 | 7.52 | 7.49 | 7.08 | 5.33 | 5.04 |
| UV | | | | | | | |
| Exposure | | | | | | | |
| Precipi- | Yes | Yes | Yes | Yes | Yes | N/A | N/A |
| tation | | | | | | | |
| After UV | | | | | | | |
| Exposure | | | | | | | |

The results of the 60% stock vehicle and the comparative 60% stock vehicle illustrate clearly illustrate the effect that the combination of the polymeric sensitizer and the photoacid generator has on the composition. Without the photoacid generator, the pH of the comparative 60% stock vehicle barely changed. In contrast, with the combination of the polymeric sensitizer and the photoacid generator, the pH of the 60% stock vehicle dropped by 1.1. The effect of the combination of the polymeric sensitizer and the photoacid generator was also observed in each of the inks and the overcoat composition. The pH of each of these solutions dropped by at least 0.97. Moreover, precipitation of the pigment was observed in each of the inks. Pigment precipitation after UV exposure is evidence that the ultraviolet radiation absorbed by the polymeric sensitizer is transferred to the photoacid generator, which becomes energy rich and breaks down to generate H+. The H+ decreases the pH and destabilizes the anionic pigment, which then fixes on whatever substrate it is printed on.

The particle size of the pigment and binder solids in each of the ink compositions and the overcoat composition was also measured before and after the 15 seconds of UV exposure. The count of particles having a size greater than 2 microns was measured using dynamic light scattering with a NANOTRAC® WAVE™ particle size analyzer (available from MICROTRAC™—NIKKISO GROUP™). The before and after results are shown in Table 4 and FIG. 4.

TABLE 4

| | Particle Size (>2 μm) | Particle Size (>2 μm) |
|---|---|---|
| | Count Before UV | Count After UV |
| | Exposure (log 10) | Exposure (log 10) |
| Black Ink | 2.96E+05 | 7.37E+07 |
| Cyan Ink | 1.84E+05 | 4.21E+06 |
| Yellow Ink | 3.38E+05 | 4.71E+05 |
| Magenta Ink | 2.39E+05 | 1.55E+06 |
| Overcoat | 3.58E+05 | 5.35E+05 |

These results indicate that creation of H⁺ after UV exposure destabilizes the pigment dispersion and latex binder and causes these particles to grow. In the case of black ink, the increase in number of particles having a size greater than 2 μm increased a couple hundred fold. Some pigments may absorb some amount of the UV light, as indicated in the Yellow ink result where the increase in number of particles having a size greater than 2 μm was the least among the inks. For the overcoat composition, the acrylic binder might tolerate more protons and be less sensitive to particle growth.

It is to be understood that the ranges provided herein include the stated range and any value or sub-range within the stated range, as if such values or sub-ranges were explicitly recited. For example, from about 360 nm to about 410 nm should be interpreted to include not only the explicitly recited limits of from about 360 nm to about 410 nm, but also to include individual values, such as about 368.5 nm, about 379.75 nm, about 384.67 nm, about 397.0 nm, about 405.2 nm, etc., and sub-ranges, such as from about 366.53 nm to about 382.5 nm, from about 380.25 nm to about 396.2 nm, from about 391.75 nm to about 408.79 nm, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A thermal inkjet fluid composition, comprising:
a water soluble photoacid generator having substantially no absorbance at a radiation wavelength ranging from about 360 nm to about 410 nm;
a water soluble polymeric sensitizer having absorption at the radiation wavelength ranging from about 360 nm to about 410 nm, the water soluble polymeric sensitizer including:
a functionalized aromatic chromophore moiety;
a polyether chain; and
an amide linkage or an ether linkage attaching one end of the polyether chain to the functionalized aromatic chromophore moiety;
a polymeric binder; and
a balance of water.

2. The thermal inkjet fluid composition as defined in claim 1 wherein an initial pH of the thermal inkjet fluid composition decreases when the thermal inkjet fluid composition is exposed to the radiation wavelength ranging from about 360 nm to about 410 nm.

3. The thermal inkjet fluid composition as defined in claim 1 wherein the thermal inkjet fluid composition is an ink, and further comprises an anionic pigment.

4. The thermal inkjet fluid composition as defined in claim 1 wherein the thermal inkjet fluid composition is an overcoat composition that is substantially colorless.

5. The thermal inkjet fluid composition as defined in claim 1 wherein:
the water soluble photoacid generator is an aromatic onium salt selected from the group consisting of a diazonium salt, a phosphonium salt, a sulfonium salt, an iodonium salt, an imidosulfonate salt, an oxime sulfonate salt, a diazodisulfone salt, a disulfonate salt, an o-nitrobenzyl sulfonate salt, and combinations thereof; and
an anion of the aromatic onium salt is selected from the group consisting of nitrate, chlorate, perchlorate, chloride, sulfate, and combinations thereof.

6. The thermal inkjet fluid composition as defined in claim 1 wherein the functionalized aromatic chromophore moiety of the water soluble polymeric sensitizer includes 3 to 4 conjugate rings and is selected from the group consisting of an anthrone moiety, an anthracene moiety, a phenanthrene moiety, a chrysene moiety, a pyrene moiety, a perylene moiety, a triphenylene moiety, a xanthene moiety, a cyanine moiety, a merocyanine moiety, an acridone moiety, an acridine moiety, an anthraquinone moiety, and a coumarin moiety.

7. The thermal inkjet fluid composition as defined in claim 1 wherein the water soluble polymeric sensitizer has a formula (I) of: 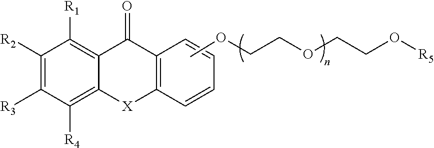
and wherein:
R₁, R₂, R₃, R₄, and R₅ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group;
R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group;
X is O, S, or NH; and
n ranges from 1 to 200.

8. The thermal inkjet fluid composition as defined in claim 1 wherein the water soluble polymeric sensitizer has a formula (II) of: 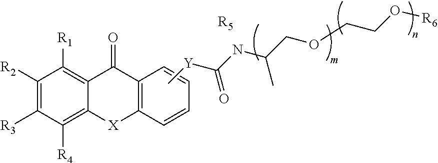
and wherein:
R₁, R₂, R₃, R₄, R₅, and R₆ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group;
R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group;
Y is a bond, (CH₂)_{q}, or O(CH₂)_{q}, wherein q is any integer from 1 to 100;
X is O, S, or NH;
m ranges from 1 to 200; and
n ranges from 1 to 200.

9. The thermal inkjet fluid composition as defined in claim 1, further comprising an additional functionalized aromatic chromophore moiety attached to an opposed end of the polyether chain through an additional ether linkage or an additional amide linkage.

10. The thermal inkjet fluid composition as defined in claim 1 wherein:
the water soluble polymeric sensitizer is present in an amount ranging from about 0.1 wt % to about 10 wt % based on a total weight of the thermal inkjet fluid composition; and
the water soluble photoacid generator is present in an amount ranging from about 0.1 wt % to about 10 wt % based on the total weight of the thermal inkjet fluid composition.

11. The thermal inkjet fluid composition as defined in claim 1 wherein the initial pH is 7 or higher.

12. A printing method, comprising:
ejecting a thermal inkjet ink composition on a substrate to form an ink layer, the thermal inkjet ink composition including:
a water soluble photoacid generator having substantially no absorbance at a radiation wavelength ranging from about 360 nm to about 410 nm;
a water soluble polymeric sensitizer having absorption at the radiation wavelength ranging from about 360 nm to about 410 nm, the water soluble polymeric sensitizer including:
a functionalized aromatic chromophore moiety;
a polyether chain; and
an amide linkage or an ether linkage attaching one end of the polyether chain to the functionalized aromatic chromophore moiety;
a polymeric binder;
an anionic pigment; and
a balance of water; and
exposing the ink layer to the radiation wavelength ranging from about 360 nm to about 410 nm, thereby decreasing an initial pH of the thermal inkjet ink composition and fixing the anionic pigment to the substrate.

13. The printing method as defined in claim 12 wherein the exposing of the ink layer is accomplished with a narrow wavelength ultraviolet light source having an emission wavelength of 365 nm, 375 nm, 385 nm, 395 nm or 405 nm.

14. A printing method, comprising:
ejecting a thermal inkjet ink composition on a substrate to form an ink layer, the thermal inkjet ink composition including an anionic pigment;
ejecting a thermal inkjet overcoat composition on the ink layer to form a coated ink layer, the thermal inkjet overcoat composition including:
a water soluble photoacid generator having substantially no absorbance at a radiation wavelength ranging from about 360 nm to about 410 nm;
a water soluble polymeric sensitizer having absorption at the radiation wavelength ranging from about 360 nm to about 410 nm, the water soluble polymeric sensitizer including:
a functionalized aromatic chromophore moiety;
a polyether chain; and
an amide linkage or an ether linkage attaching one end of the polyether chain to the functionalized aromatic chromophore moiety;
a polymeric binder; and
a balance of water; and
exposing the coated ink layer to the radiation wavelength ranging from about 360 nm to about 410 nm, thereby decreasing an initial pH of the thermal inkjet overcoat composition and fixing the anionic pigment to the substrate.

15. The printing method as defined in claim 14 wherein the exposing of the coated ink layer is accomplished with a narrow wavelength ultraviolet light source having an emission wavelength of 365 nm, 375 nm, 385 nm, 395 nm or 405 nm.
